(19) United States
(12) Patent Application Publication
(10) Pub. No.: US 2026/0038471 A1
(43) Pub. Date: Feb. 5, 2026

(54) ACOUSTIC ABSORPTION STRUCTURE COMPRISING COMPARTMENTALIZED CELLS COMBINING A PLURALITY OF TYPES OF RESONATORS

(71) Applicant: Airbus Operations SAS, TOULOUSE (FR)

(72) Inventors: Arnulfo CARAZO MENDEZ, TOULOUSE (FR); Léana ROSSI, TOULOUSE (FR); Suresh PALANI, TOULOUSE (FR); Kevin BOUKHORS, TOULOUSE (FR); Maelle ALBERT, TOULOUSE (FR)

(21) Appl. No.: 19/288,096

(22) Filed: Aug. 1, 2025

(30) Foreign Application Priority Data
Aug. 2, 2024 (FR) 2408576

(51) Int. Cl. G10K 11/172; G10K 11/168

(52) U.S. Cl. CPC G10K 11/172; G10K 11/168

(57) ABSTRACT

An acoustic absorption structure having a cellular structure, interposed between an acoustically resistive layer and a reflective layer, which has walls delimiting cells and, for at least one cell: at least one, and at most three, L-shaped partitions which are impermeable and spaced apart from one another and which delimit a straight compartment and at least one L-shaped compartment, in each L-shaped compartment an inclined acoustically resistive porous partition which has a perforation rate of less than or equal to 15% and divides the L-shaped compartment into first and second zones forming two types of resonators. Also an aircraft with at least one such acoustic absorption structure.

### CROSS-REFERENCES TO RELATED APPLICATIONS

This application claims the benefit of French Patent Application Number FR2408576 filed on Aug. 2, 2024, the entire disclosure of which is incorporated herein by way of reference.

### FIELD OF THE INVENTION

The present application relates to an acoustic absorption structure comprising compartmentalized cells combining a plurality of types of resonators and an aircraft comprising at least one such acoustic absorption structure.

### BACKGROUND OF THE INVENTION

According to one configuration, an aircraft propulsion unit comprises a nacelle and a double-flow turbomachine, positioned inside the nacelle, which has at the rear a primary ejection duct via which the burnt gases resulting from the combustion are evacuated. This primary ejection duct comprises an acoustic absorption structure in the region of its skin in order to attenuate the noise over a plurality of frequency bands, such as noise associated with combustion (300-1,000 Hz) and that associated with the operation of the turbine (greater than or equal to 4,000 Hz).

According to a first embodiment of the prior art, an acoustic absorption structure comprises at least one cellular structure positioned between an acoustically resistive layer (porous) in contact with a medium in which acoustic waves travel and a reflective layer (impermeable). The cellular structure comprises a plurality of tubular cells, each closed at a first end by the acoustically resistive layer and at a second end by the reflective layer. These cells are not compartmentalized and are generally configured to target a single resonance frequency as a function of the height of the cells. This first embodiment makes it possible to obtain a quarter-wave resonator capable of attenuating high-frequency sound waves.

This first embodiment is not entirely satisfactory since it allows only a small range of frequencies to be treated.

According to a second embodiment of the prior art, an acoustic absorption structure comprises first and second cellular structures positioned between an acoustically resistive layer in contact with a medium in which acoustic waves travel and a reflective layer. This acoustic absorption structure comprises an acoustically resistive porous partition interposed between the first and second cellular structures, the first cellular structure being interposed between the acoustically resistive layer and the acoustically resistive porous partition, the second cellular structure being interposed between the reflective layer and the acoustically resistive porous partition.

This second embodiment makes it possible to obtain two types of resonators, a first resonator of the Helmholtz type in the region of the cells of the first cellular structure, capable of attenuating low-frequency sound waves, and a second resonator of the quarter-wave type in the region of the cells of the second cellular structure, capable of attenuating high-frequency sound waves.

Although this second embodiment makes it possible to increase the range of frequencies of the acoustic waves treated, it is not entirely satisfactory since the acoustic absorption structure has a significant thickness.

According to a third embodiment of the prior art, illustrated in FIG. 1 and described in the document EP 2466095, an acoustic absorption structure comprises a plurality of angled cells 10, each angled cell 10 comprising a first compartment 10.1 which extends in a first direction between an acoustically resistive layer 12 in contact with a medium in which acoustic waves travel and an acoustically resistive porous partition 14 substantially parallel to the acoustically resistive layer 12, and a second compartment 10.2 which extends in a second direction substantially perpendicular to the first direction between the acoustically resistive porous partition 14 and a reflective layer 16.

As in the second embodiment, this third embodiment makes it possible to obtain two types of resonators and to increase the range of frequencies of the acoustic waves treated. Although providing angled cells 10 enables the thickness of the acoustic absorption structure to be reduced relative to the second embodiment, this third embodiment is not entirely satisfactory since the density of the surfaces in line with the cells is relatively low.

According to a fourth embodiment of the prior art, illustrated in FIG. 2, the cells 20 of an acoustic absorption structure are positioned between an acoustically resistive layer 22 in contact with a medium in which acoustic waves travel and a reflective layer 24. Each cell 20 comprises an inclined partition 26 which is porous on at least one zone, dividing the cell 20 into two compartments 20.1, 20.2.

As in the second and third embodiments, this fourth embodiment makes it possible to obtain two types of resonators in each cell 20 and to increase the range of frequencies of the acoustic waves treated.

According to a fifth embodiment of the prior art, visible in FIG. 3, the cells 30 of an acoustic absorption structure are positioned between an acoustically resistive layer 32 in contact with a medium in which acoustic waves travel and a reflective layer 34. Each cell 30 comprises six partitions in a V-shape 36 delimiting six angled compartments 30.1 to 30.6 and a straight compartment 30.7. Each angled compartment 30.1 to 30.6 comprises an acoustically resistive porous partition 38 dividing the angled compartment 30.1 to 30.6 into two zones.

Taking account of the small surface area of the acoustically resistive porous partition 38 and the specific minimum passage cross section of the holes passing through the partition, whatever their methods of manufacture, each acoustically resistive porous partition 38 has a relatively high perforation rate of the order of 20%. In contrast to the second, third and fourth embodiments, the acoustically resistive porous partitions 38 do not enable two types of resonators to be obtained in the different angled compartments 30.1 to 30.6 due to their perforation rate, which is too high.

Whatever the embodiment of the prior art, there is a need to increase the range of frequencies of the acoustic waves treated.

### SUMMARY OF THE INVENTION

To this end, the subject of the invention is an acoustic absorption structure comprising an acoustically resistive layer, a reflective layer and a cellular structure interposed between the acoustically resistive layer and the reflective layer, said cellular structure comprising a first face in contact with the acoustically resistive layer, a second face in contact with the reflective layer and walls parallel to a longitudinal direction which delimit cells, each leading into the region of the first and second faces.

According to the invention, the cellular structure comprises, for at least one cell:
a. at least one, and at most three, L-shaped partitions which are impermeable and spaced apart from one another and which each have first and second side portions connected by a joint line, respectively substantially parallel to the longitudinal direction and perpendicular to the longitudinal direction and delimiting a straight compartment and at least one L-shaped compartment,
b. in each L-shaped compartment an inclined acoustically resistive porous partition which has a perforation rate of less than or equal to 15% and divides the L-shaped compartment into first and second zones forming two types of resonators.

Providing a limited number of L-shaped partitions makes it possible to obtain a sufficiently large surface area for each inclined acoustically resistive porous partition in order to be able to achieve a perforation rate of less than 20%, which makes it possible to obtain two types of resonators in each of the first and second L-shaped compartments. Moreover, providing L-shaped compartments makes it possible to increase the distance covered by the acoustic waves therein between the acoustically resistive layer and the resistive layer while limiting the thickness of the cellular structure.

This solution makes it possible to increase the range of frequencies of the acoustic waves treated.

According to a further feature, the different acoustically resistive porous partitions connect the different joint lines of the different L-shaped partitions, one of the acoustically resistive porous partitions being tangent to the second face of the cellular structure.

According to a further feature, each cell comprises two L-shaped partitions delimiting a straight compartment and two L-shaped compartments.

According to a further feature, the second side portion of the first L-shaped compartment and the acoustically resistive layer are spaced apart by a first distance, the second side portion of the second L-shaped partition and the reflective layer being spaced apart by a second distance and the second side portions of the first and second L-shaped partitions being spaced apart by a third distance. In addition, each cell has a cell height; the first, second and third distances being between 25% and 40% of the cell height of the cell.

According to a further feature, the first, second and third distances are substantially equal to one another.

According to a further feature, the first side portion of the first L-shaped partition and the wall are spaced apart by a first maximum distance, the first side portion of the second L-shaped partition and the wall being spaced apart by a second maximum distance and the first side portions of the first and second L-shaped partitions being spaced apart by a third maximum distance. In addition, each cell has a cell diameter; the first, second and third maximum distances being between 25% and 40% of the cell diameter of the cell.

According to a further feature, the first, second and third maximum distances are substantially equal to one another.

A further subject of the invention is an aircraft comprising at least one acoustic absorption structure according to one of the preceding features.

### BRIEF DESCRIPTION OF THE DRAWINGS

Further features and advantages will become apparent from the following description of the invention, the description being provided solely by way of example with reference to the accompanying drawings, in which:

FIG. 1 is a schematic view of a cell of an acoustic absorption structure illustrating an embodiment of the prior art,

FIG. 2 is a schematic view of a cell of an acoustic absorption structure illustrating a further embodiment of the prior art,

FIG. 3 is a schematic view of a cell of an acoustic absorption structure illustrating a further embodiment of the prior art,

FIG. 4 is a side view of an aircraft,

FIG. 5 is a longitudinal section of a part of a propulsion unit,

FIG. 6 is a schematic view in perspective of a cell of an acoustic absorption structure illustrating an embodiment of the invention,

FIG. 7 is a schematic section of the cell visible in FIG. 6,

FIG. 8 is a section in perspective of a cell of an acoustic absorption structure illustrating an embodiment of the invention,

FIG. 9 is a diagram showing acoustic attenuation curves obtained from compartments of a cell of an acoustic absorption structure according to the invention.

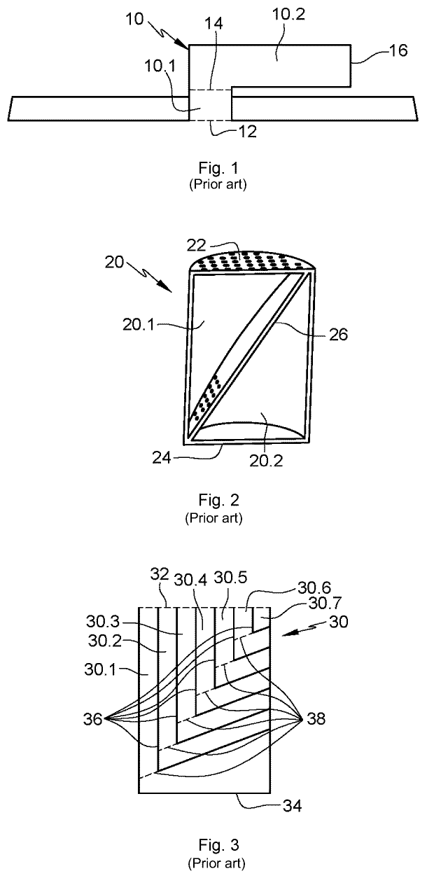

### DETAILED DESCRIPTION OF THE PREFERRED EMBODIMENTS

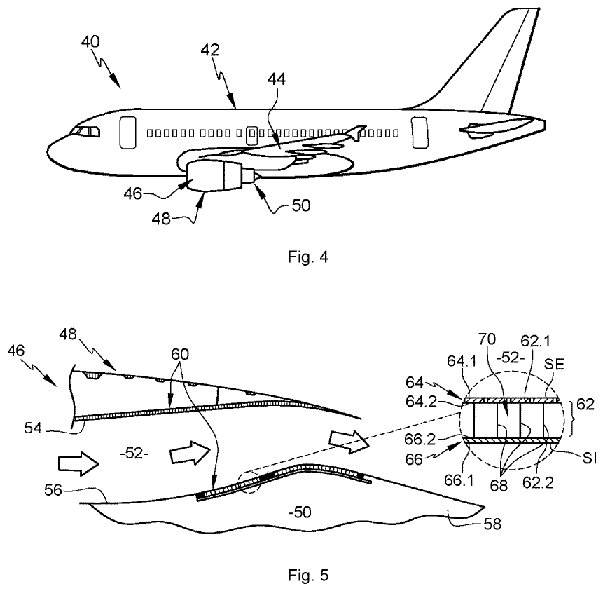

An aircraft 40 which has a fuselage 42, two wings 44 arranged on either side of the fuselage 42 and propulsion units 46 fixed below the wings 44, has been shown in FIG. 4. Each propulsion unit 46 comprises a nacelle 48 and a turbomachine 50 positioned inside the nacelle 48.

According to an embodiment visible in FIG. 5, the turbomachine 50 comprises, at the rear, a primary ejection duct 52 via which gases burnt in the turbomachine 50 are evacuated and which is delimited externally by an external wall 54 and internally by an internal wall 56 extended by a nozzle cone 58.

According to one configuration, the external and internal walls 54, 56 each comprise at least one acoustic absorption structure 60.

Each acoustic absorption structure 60 comprises an external surface SE in contact with a medium in which acoustic waves travel, and an internal surface SI opposing the external surface SE.

Although the invention is described applied to a primary ejection duct 52, it is not limited to this application. Thus, the acoustic absorption structure 60 can be positioned in the region of any wall which has an external surface SE in contact with a medium in which sound waves travel.

Each acoustic absorption structure 60 comprises at least one cellular structure 62 interposed between an acoustically resistive layer 64 which is permeable to sound waves and a reflective layer 66 which is impermeable to sound waves. The acoustically resistive layer 64 has a first face 64.1 corresponding to the external surface SE and a second face 64.2 which is oriented toward the cellular structure 62 and connected thereto. The reflective layer 66 has a first face 66.1 corresponding to the internal surface SI and a second face 66.2 which is oriented toward the cellular structure 62 and connected thereto.

The acoustically resistive layer 64, the reflective layer 66, the connection between the acoustically resistive layer 64 and the cellular structure 62 and the connection between the reflective layer 66 and the cellular structure 62 are not described further since they may be identical to those of the prior art.

The cellular structure 62 extends between a first face 62.1 in contact with the acoustically resistive layer 64 and a second face 62.2 in contact with the reflective layer 66 and comprises a plurality of walls 68 which each have first and second edges respectively positioned in the region of the first and second faces 62.1, 62.2. These walls 68 are configured to delimit cells 70 which each lead into the region of the first and second faces 62.1, 62.2.

According to one embodiment, the walls 68 are tubular and parallel to a longitudinal direction DL. According to one configuration, the walls 68 are cylindrical.

According to one arrangement, each cell 70 has a cell diameter D70 of between 9.6 and 19.1 mm and a cell height H70 of between 30 and 70 mm.

For at least one cell, the cellular structure 62 comprises at least one L-shaped partition 72 which has a first side portion 74 substantially (+/−10%) parallel to the longitudinal direction DL and a second side portion 76 substantially perpendicular to the longitudinal direction DL. Each L-shaped partition 72 is impermeable.

For each L-shaped partition 72 the first side portion 74 is substantially rectangular and has a first transverse edge 74.1 located in the region of the first face 62.1, a second transverse edge 74.2 substantially parallel to the first transverse edge 74.1 and connected to the second side portion 76 and first and second longitudinal edges 74.3, 74.4 parallel to one another and connected to the wall 68. The second side portion 76 comprises a first rectilinear edge 76.1 connected to the second transverse edge 74.2 in the region of a joint line 78 and a second angled edge 76.2 connected to the wall 68.

The L-shaped partition 72 delimits a straight empty compartment 70.1, delimited by a part of the acoustically resistive layer 64, the first and second side portions 74, 76 of the L-shaped partition 72 and a part of the wall 68, said straight compartment 70.1 forming a quarter-wave resonator capable of attenuating high-frequency sound waves.

The cell 70 comprises at least one L-shaped compartment 70.2 separated from the straight compartment 70.1 by the L-shaped partition 72.

The cellular structure 62 comprises, for each L-shaped compartment 70.2, an inclined acoustically resistive porous partition 80 which is positioned in the L-shaped compartment 70.2 and which separates it into first and second zones 80.1, 80.2 located on either side of the acoustically resistive porous partition 80. This acoustically resistive porous partition 80 has a perforation rate of less than or equal to 15%, preferably less than or equal to 10%. Thus the first and second zones 80.1, 80.2 form two types of resonators, respectively a first resonator of the Helmholtz type capable of attenuating low-frequency sound waves and a second quarter-wave resonator capable of attenuating high-frequency sound waves.

According to one embodiment, the cellular structure 62 comprises at most three L-shaped partitions spaced apart from one another.

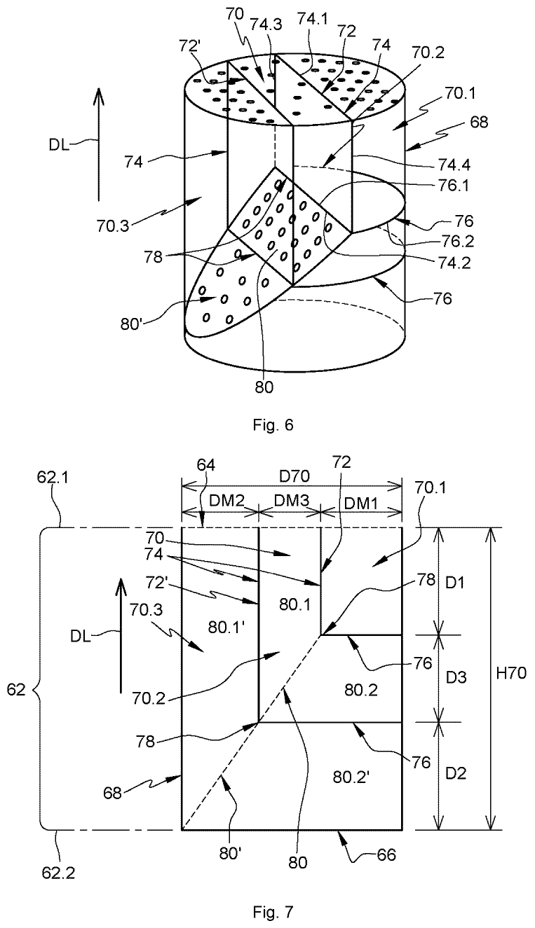

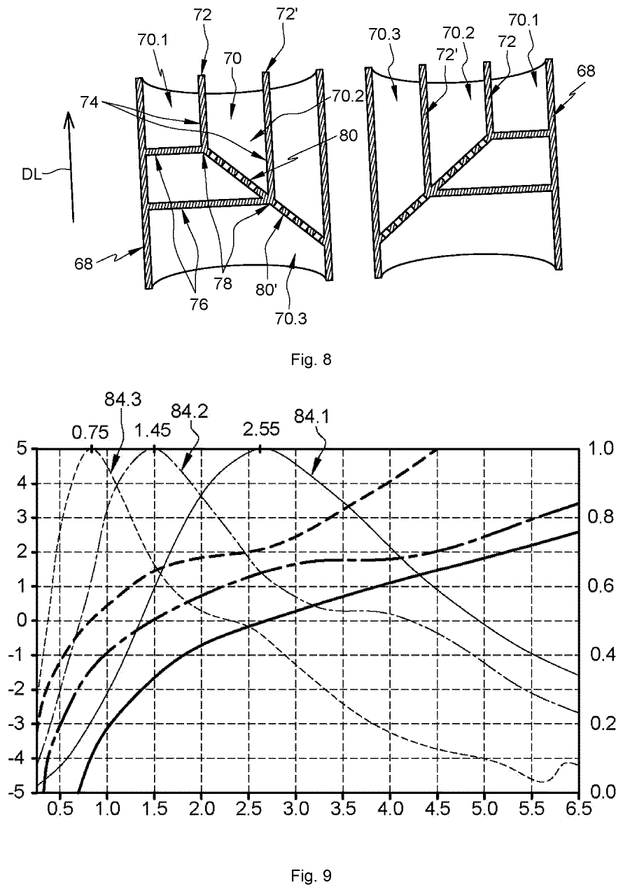

Ideally the cellular structure 62 comprises:
c. two L-shaped partitions 72, 72′ spaced apart from one another, as illustrated in FIGS. 6 to 8, delimiting an empty straight compartment 70.1 and first and second L-shaped compartments 70.2, 70.3,
d. and for each of the first and second L-shaped compartments 70.2, 70.3 an inclined acoustically resistive porous partition 80, 80′, one in each L-shaped compartment 70.2, 70.3 dividing each into the first and second zones 80.1, 80.2, 80.1′, 80.2′ located on either side of the acoustically resistive porous partition 80, 80′.

According to one configuration, the different inclined acoustically resistive porous partitions 80, 80′ are coplanar and connected to the different joint lines 78 of the different L-shaped partitions 72, 72′, one of the inclined acoustically resistive porous partitions 80′ being tangent to the second face 62.2 of the cellular structure 62.

The second side portion 76 of the first L-shaped partition 72 and the acoustically resistive layer 64 are spaced apart by a first distance D1 substantially (within 90%) equal to a second distance D2 separating the second side portion 76 from the second L-shaped partition 72′ and the reflective layer 66. The second side portions 76 of the first and second L-shaped partitions 72, 72′ are spaced apart by a third distance D3 substantially equal to the first and second distances D1, D2.

The first, second and third distances D1, D2, D3 are between 25% and 40% of the cell height H70 of the cell 70.

The first side portion 74 of the first L-shaped partition 72 and the wall 68 are spaced apart by a first maximum distance DM1 substantially equal to a second maximum distance DM2 separating the first side portion 74 of the second L-shaped partition 72′ and the wall 68. The first side portions 74 of the first and second L-shaped partitions 72, 72′ are spaced apart by a third maximum distance DM3 substantially equal to the first and second maximum distances DM1, DM2.

The first, second and third maximum distances DM1, DM2, DM3 are between 25% and 40% of the cell diameter D70 of the cell 70.

According to one configuration, the acoustically resistive layer 64 has a substantially uniform perforation rate in line with the cell 70. As a variant, the acoustically resistive layer 64 can have a non-uniform perforation rate in line with the cell 70. By way of example, the zones in line with the straight compartment 70.1 and the first and second L-shaped compartments 70.2, 70.3 can have different perforation rates from one zone to the other.

Each of the inclined acoustically resistive porous partitions 80, 80′ has a substantially uniform perforation rate. As a variant, at least one inclined acoustically resistive porous partition 80, 80′ can have a non-uniform perforation rate.

The invention makes it possible to obtain a plurality of types of resonators in a cell 70 of low height. Providing a limited number of L-shaped partitions 72, at most equal to three, makes it possible to obtain a surface for each inclined acoustically resistive porous partition 80, 80′ which is sufficiently large in order to be able to achieve a perforation rate of less than 20%, which makes it possible to obtain two types of resonators in each of the first and second L-shaped compartments 70.2, 70.3.

Finally, providing L-shaped compartments 70.2, 70.3 makes it possible to increase the distance covered by the acoustic waves therein between the acoustically resistive layer 64 and the reflective layer 66. Since the different L-shaped compartments 70.2, 70.3 are nested in one another, they have different lengths, which contributes to increasing the range of frequencies of the acoustic waves treated.

In the case of a cell 70 having a cell height H70 of the order of 40 mm, the distance covered by the acoustic waves is of the order of 15 mm in the straight compartment 70.1, of the order of 30 mm in the first L-shaped compartment 70.2 and of the order of 57.5 mm in the second L-shaped compartment 70.3. As illustrated in FIG. 9, the straight compartment 70.1 makes it possible to obtain an attenuation of the acoustic waves which follows a first curve 84.1 having a peak at a frequency of the order of 2.55 kHz. The first L-shaped compartment 70.2 makes it possible to obtain an attenuation of acoustic waves which follows a second curve 84.2 having a peak at a frequency of the order of 1.45 KHz. Finally the second L-shaped compartment 70.3 makes it possible to obtain an attenuation of the acoustic waves which follows a third curve 84.3 having a peak at a frequency of the order of 0.75 kHz.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. An acoustic absorption structure comprising:
an acoustically resistive layer;
a reflective layer; and
a cellular structure interposed between the acoustically resistive layer and the reflective layer,
the cellular structure comprising a first face in contact with the acoustically resistive layer, a second face in contact with the reflective layer, and walls parallel to a longitudinal direction, delimiting cells which each lead into a region of the first face and the second face,
wherein the cellular structure comprises, for at least one cell, at least one, and at most three, L-shaped partitions which are impermeable and spaced apart from one another and which each have first and second side portions connected by a joint line, respectively substantially parallel to the longitudinal direction and perpendicular to the longitudinal direction and delimiting a straight compartment and at least one L-shaped compartment, and
in each L-shaped compartment an inclined acoustically resistive porous partition which has a perforation rate of less than or equal to 15% and which divides the L-shaped compartment into a first zone and a second zone forming two types of resonators.

2. The acoustic absorption structure as claimed in claim 1, wherein the acoustically resistive porous partitions connect the joint lines of the L-shaped partitions, and
wherein one of the acoustically resistive porous partitions is tangent to the second face of the cellular structure.

3. The acoustic absorption structure as claimed in claim 1, wherein each cell comprises two L-shaped partitions delimiting a straight compartment and two L-shaped compartments.

4. The acoustic absorption structure as claimed in claim 3, wherein the second side portion of a first L-shaped partition and the acoustically resistive layer are spaced apart by a first distance,
wherein the second side portion of a second L-shaped partition and the reflective layer are spaced apart by a second distance,
wherein the second side portions of the first L-shaped partition and the second L-shaped partition are spaced apart by a third distance,
wherein each cell has a cell height, and
wherein the first distance, the second distance, and the third distance being between 25% and 40% of the cell height of the cell.

5. The acoustic absorption structure as claimed in claim 4, wherein the first distance, the second distance, and the third distance are substantially equal to one another.

6. The acoustic absorption structure as claimed in claim 4, wherein the first side portion of the first L-shaped partition and the wall are spaced apart by a first maximum distance,
wherein the first side portion of the second L-shaped partition and the wall are spaced apart by a second maximum distance,
wherein the first side portions of the first L-shaped partition and the second L-shaped partition are spaced apart by a third maximum distance
wherein each cell has a cell diameter, and
wherein the first maximum distance, the second maximum distance, and the third maximum distance being between 25% and 40% of the cell diameter of the cell.

7. The acoustic absorption structure as claimed in claim 6, wherein the first maximum distance, the second maximum distance, and the third maximum distance are substantially equal to one another.

8. An aircraft comprising:
at least one acoustic absorption structure as claimed in claim 1.
